(19) United States
(12) Patent Application Publication
(10) Pub. No.: US 2006/0269098 A1
(43) Pub. Date: Nov. 30, 2006

(54) Image processing apparatus, image processing method, medium, code reading apparatus, and program

(75) Inventor: Kenji Ebitani, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/260,155

(22) Filed: Oct. 28, 2005

(30) Foreign Application Priority Data
May 31, 2005 (JP) 2005-158538

(51) Int. Cl. G06K 9/00

(52) U.S. Cl. 382/100

(57) ABSTRACT

An image processing apparatus includes first and second synthesizing sections and an outputting section. The first synthesizing section synthesizes a code image with a part of an original image. The code image has a size smaller than that of the original image. The second synthesizing section synthesizes a marker image with another part of the original image outside the code image. The outputting section outputs a synthesized image in which the original image, the code image and the marker image are synthesized. The marker image includes a first region colored with a first color and a second region colored with a second color different from the first color. At least a part of the second region is in contact with the first region. The marker image is used to correct slant of the code image when decoding the code image.

### BACKGROUND

1. Technical Field

This invention relates to an image processing apparatus for synthesizing a code image such as an digital watermark.

2. Related Art

Recently, there has been known a technique, referred to as digital watermarking, of embedding a code image into an original image for the purpose of preventing an image formed on a medium from being altered. In the digital watermarking, by various methods, a code image is synthesized with and embedded into an original image in such a form that it is difficult for a human to recognize.

A user captures with a camera an image with which an digital watermark of this kind has been synthesized. From the captured image, a code expressed by the code image is decoded.

However, depending on the image capturing conditions of the camera, it sometimes happens that the image of the digital watermark is captured with slanted, or is captured with a depth (e.g., the image may be captured in a state where a part of the image is closer to the cameral than another part of the image). The digital watermark is also sometimes picked up in a state in which it has suffered so-called “tilt”.

In view of these circumstances, the invention provides an image processing apparatus with which it is possible to form an easily detectable marker for correction without impairing the visual effect of an original image.

### SUMMARY

According to one embodiment of the invention, an image processing apparatus includes first and second synthesizing sections and an outputting section. The first synthesizing section synthesizes a code image with a part of an original image. The code image has a size smaller than that of the original image. The second synthesizing section synthesizes a marker image with another part of the original image outside the code image. The outputting section outputs a synthesized image in which the original image, the code image and the marker image are synthesized. The marker image includes a first region colored with a first color and a second region colored with a second color different from the first color. At least a part of the second region is in contact with the first region. The marker image is used to correct slant of the code image when decoding the code image.

According to one embodiment of the invention, an image processing method includes synthesizing a code image with a part of an original image, the code image having a size smaller than that of the original image; synthesizing a marker image with another part of the original image outside the code image; and outputting a synthesized image in which the original image, the code image and the marker image are synthesized. The marker image includes a first region colored with a first color and a second region colored with a second color different from the first color. At least a part of the second region is in contact with the first region. The marker image is used to correct slant of the code image when decoding the code image.

One embodiment of the invention provides a medium on which a synthesized image is formed. In the synthesized image, an original image, a code image and a marker image are synthesized. The code image has a size smaller than that of the original image. The marker image includes a first region colored with a first color and a second region colored with a second color different from the first color. At least a part of the second region is in contact with the first region. The marker image is synthesized with a part of the original image outside the code image.

According to one embodiment of the invention, a code reading apparatus includes a generating section, an image processing section and an outputting section. The generating section captures the medium described above to generate image data. The image processing section detects the marker image from the generated image data and applies a predetermined image process to the generated image data on a basis of the code data. The outputting section detects the code image from image data, which has been subject to the predetermined image process, encodes the detected code image and outputs a result of decoding.

According to one embodiment of the invention, a program is stored in a recording medium. The program causes a computer to execute a process including synthesizing a code image with a part of an original image, the code image having a size smaller than that of the original image; synthesizing a marker image with another part of the original image outside the code image; and outputting a synthesized image in which the original image, the code image and the marker image are synthesized. The marker image includes a first region colored with a first color and a second region colored with a second color different from the first color. At least a part of the second region is in contact with the first region. The marker image is used to correct slant of the code image when decoding the code image.

According to the above-described configuration, the marker image includes the first region colored with the first color and the second region colored with the second color different from the first color. At least the part of the second region is in contact with the first region. The marker image is synthesized with a part of the original image outside the code image. Since the marker image includes the two color regions, a correction marker can be synthesized inside the original image in an easily detectable state, irrespective of colors of the original image. Therefore, an easily recognizable image is not arranged at the outer periphery of the original image, so that there is no impairment of the visual effect of the original image.

### BRIEF DESCRIPTION OF THE DRAWINGS

FIG. 1 is a construction block diagram showing an example of an image processing apparatus and a symbol-extracting apparatus according to an embodiment of the invention;

FIG. 2 is an explanatory view illustrating an example of a marker image according to an embodiment of the invention;

FIG. 3 is a flow chart showing an example of the operation of an image processing apparatus according to an embodiment of the invention;

FIG. 4 is an explanatory view illustrating an example of a code image insertion region in an image processing apparatus according to an embodiment of the invention;

FIG. 5 is an explanatory view illustrating an example of a marker image insertion method in an image processing apparatus according to an embodiment of the invention;

FIG. 6 is an explanatory view illustrating an example of a marker image and a code image extracted in an embodiment of the invention.

### DETAILED DESCRIPTION

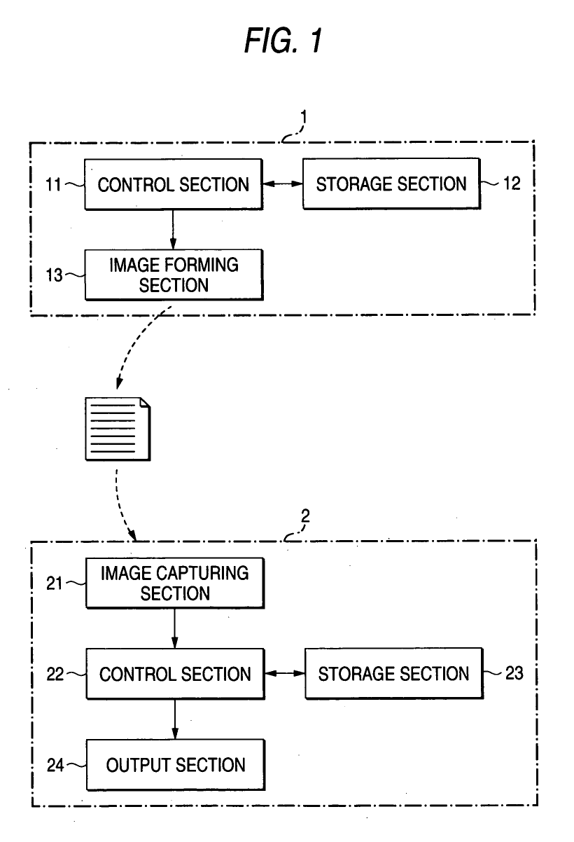

An embodiment of the invention will be described with reference to the accompanying drawings. An image processing apparatus 1 according to an embodiment of the invention, as shown in FIG. 1, includes a control section 11, a storage section 12 and an image forming section 13. And, a code reading apparatus 2 shown in FIG. 1 reads a medium processed by the image processing apparatus 1. This code reading apparatus 2 is constructed including an image capturing section 21, a control section 22, a storage section 23 and an output section 24.

The control section 11 of the image processing apparatus 1 is a programmable information processing device such as a CPU. Here, the image processing apparatus operates in accordance with a program stored in the storage section 12. This control section 11 executes a process for synthesizing with a part of an original image stored in the storage section 12 a code image of a size smaller than that of the original image. Also, the control section 11 executes a process for synthesizing a marker image in a part in the original image and outside the code image. The marker image is used in a process applied to the code image such as a tilt correction process. A more specific example of the process carried out by this control section 11 will be discussed in detail later.

The storage section 12 includes a storage device such as RAM (Random Access Memory) and a computer-readable recording medium such as a hard disk or an external storage medium. The external storage medium of the storage section 12 such as an optical magnetic disc stores a program to be executed by the control section 11 and parameters (original images, code images and so on). The storage section 12 also serves as a working memory of the control section 11. The image forming section 13 is a printer, and forms an image on a medium such as paper on the basis of image data input from the control section 11. This image forming section 13 form images with, for example, four colors of CMYK (Cyan, Magenta, Yellow and Black).

The image capturing section 21 of the code reading apparatus 2 is a CCD camera or the like, and captures an image including a target medium to be captured and outputs image data representing the captured image to the control section 22. The output image data is of RGB (Red, Green and Blue) color space.

The control section 22 is a programmable information processing device such as a CPU. Here, the control section 22 operates in accordance with a program stored in the storage section 23. This control section 22 performs a process for detecting a marker image from image data input from the image capturing section 21, and executes a predetermined image processing on the image data on the basis of the result of the marker-image detecting. From the image data, which has been subject to the predetermined image process, the control section 22 detects, decodes and outputs a code image. An example of the process executed by the control section 22 will be discussed later.

The storage section 23 includes a storage device such as RAM (Random Access Memory) and a computer-readable recording medium such as a hard disk. For example, a hard disk of the storage section 23 stores a program to be executed by the control section 22. The storage section 23 also serves as a working memory of the control section 22.

The output section 24 may be a display device for displaying a result of the decoding of the code image output from the control section 22, and/or a printer for printing the result of the decoding of the code image.

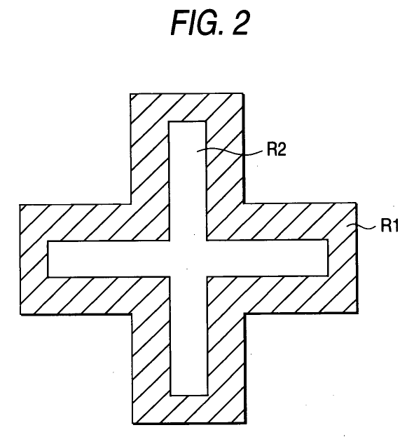

Next, an example of the operation of the control section 11 of the image processing apparatus 1 will be described. In this embodiment, as shown in FIG. 2, a marker image synthesized by the control section 11 includes a first region R1 in a shape of cross and a second region R2, which is surrounded by the first region R1 and also be in the shape of cross. The first region R1 and the second region R2 are respectively colored with a first color and a second color, which are different from each other. For example, it is assumed that colors are expressed in RGB (Red, Green and Blue) color space and that each color component thereof is expressed in gradations of from 0 to 255. In this case, the first color and the second color may have red components and green components both of which are 0 and have blue components different from each other. More specifically, the blue component of the first color may be 0, and the blue component of the second color may be 255. Because it is only necessary that the first color and the second color has a difference in gradation, the blue components of the first and second colors do not have to be 0 and 255. Alternatively, for example, the blue component of the first color may be a (a<127), and the blue component of the second color may be b (b>127). In this case, the first color and the second color may be in the vicinities of 0 and 255 (colors whose differences from 0 or 255 are below a predetermined threshold value).

The image forming section 13 forms an image in CMYK, while the marker image is formed in RGB color space. This is because when the image reading apparatus 2 reads the synthesized image into which the marker image has been synthesized, the image reading apparatus 2 generates image data having color components of RGB color space. That is, in this embodiment, the colors of the marker image are determined based on a relation with color components of data of a read synthesized image in the color space. With this configuration, it is possible to make the process in the code reading apparatus 2 simple.

In this embodiment, the marker image thus includes a plurality of mutually adjacent regions of different colors. That is, the marker image includes at least a first color region and a second color region. At least a part of the second color region is in contact with the first region. A color of the first region is different from a color of the second region. According to this configuration, it is possible to embed the marker image into the original image distinguishably irrespective of colors of the original image.

That is, even if a region of an original image where a marker image should be synthesized is painted out with a color substantially the same color as one of the first and second colors of the marker image (for example the first color), according to the marker image of this embodiment, it is possible to recognize the marker image with using a portion of the other color (for example the second color).

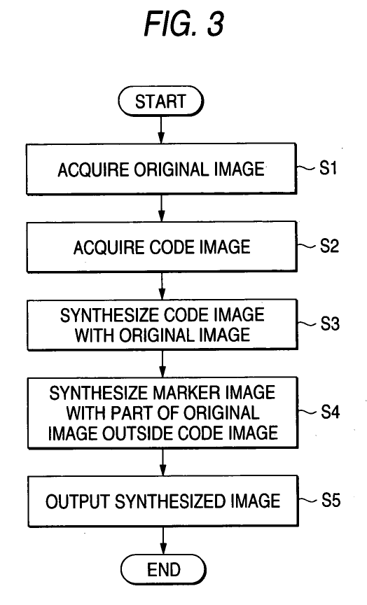

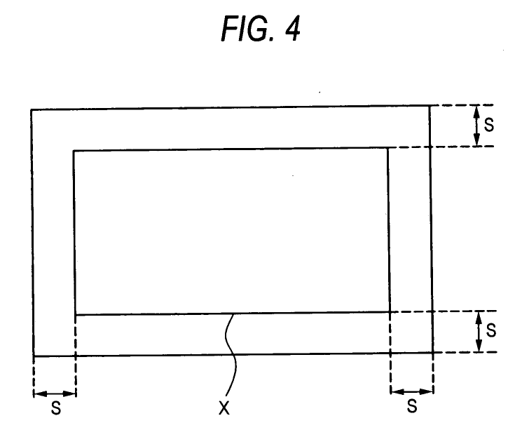

Next, an operation example of the control section 11 will be described. The control section 11 operates as follows in accordance with the program stored in the storage section 12. That is, the control section 11, as shown in FIG. 3, reads an original image stored in the storage section 12 to thereby acquire the original image (S1). Also, the control section 11 reads a code image stored in the storage section 12 to thereby acquire the code image (S2). Then, the control section 11 synthesizes the code image with the original image (S3). A method well known as the digital water marking may be used as the synthesizing method. In this embodiment, the code image is smaller in size than the original image. Also, the control section 11 synthesizes the code image into a region, which is shifted toward inside of the original image by the size s of the marker image (region X shown in FIG. 4). Here, the marker image inscribes a square of s×s. However, the marker image may be inscribe a rectangle (for example, sx×sy). In this case, sx and sy are changed so that shift amount in x direction and that in y direction, which define the above-described region, are different from each other.

The control section 11 then synthesizes the marker image outside the region where the code image has been synthesized (S4). For example, the control section 11 arranges marker images at positions corresponding to four vertexes of the rectangle surrounding the code image. The synthesizing method replaces a part of color components of pixels corresponding to the positions on the original image where the maker image has been synthesized, with color components of pixels corresponding to the marker image. A specific example of the synthesizing method will be described below in the case the marker image is has a size of 3×3, the blue component of a center pixel is 0 and the blue components of pixels peripheral to the center pixel are 255.

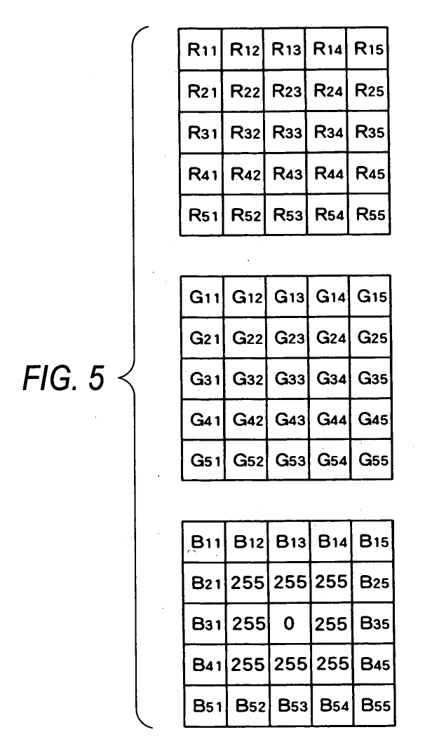

In the example, the marker image is synthesized into an original image of 5×5 region (that is, the original image has red components R11 to R55, green components G11 to G55 and blue components B11 to B55). In this case, the marker image is synthesized only into the blue components of the original image (because its red and green components are all equal to the same value, such as 0, no image is synthesized into those components). That is, in this case, as shown in FIG. 5, some of the blue components of the original image are replaced with blue components of the marker image.

The control section 11 converts the synthesized image in which the code image and the marker image are synthesized into an image of the CMYK color space and outputs the converted image to the image forming section 13 (S5), and terminates the process.

The image forming section 13 forms the synthesized image on a medium, such as paper, on the basis of image data of the synthesized image input from the control section 11. Accordingly, synthesized are the original image and the code image having a size smaller than that of the original image in a part of the original image. The image forming section 13 outputs the medium on which an image is formed in which the marker image synthesized inside the original image so that: the marker image is outside the code image; the marker image has a first color region and a second color region; at least a part of the second color region is in contact with the first region; and a color of the first color region is different from that of the second color region.

In this embodiment, since the colors of the marker image is made the blue components of the RGB color space, for example, a user visually recognizes a portion whose blue component is 0 on general original images as a portion slightly yellowish. Because generally it is hard for a human being to recognize yellow visually, the color of the marker image is made blue so that the marker image is not conspicuous in the original image.

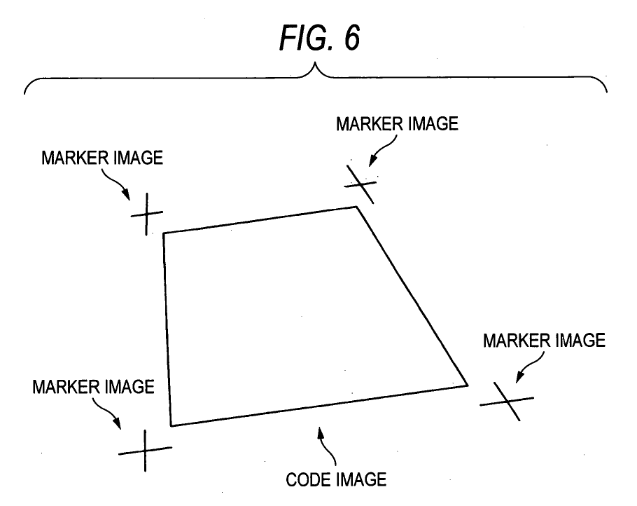

Next, the process executed by the control section 22 of the code reading apparatus 2 will be described. This control section 22 receives the image data input from the image capturing section 21. In the image data, a synthesized image in which a code image and a marker image are synthesized with an original is captured. In the captured image, the synthesized image may be captured with slant. For example, FIG. 6 shows an example where a synthesized image is captured not only with slant in plane, but also with slant in a viewing direction (depth direction) of the camera. For the sake of facilitating to understand, an original image is omitted in FIG. 6.

The control section 22 detects the marker image from this image data. Here, it is assumed that, blue components of the marker image are synthesized as described above. Accordingly, the control section 22 performs the process only on the blue component data of the image data input from the image capturing section 21.

The control section 22 then detects a predetermined marker image from this blue component data. The detection process may be executed by a general pattern recognition process. The control section 22, next, estimates from the marker image the slant of the image, and performs a geometric transformation to correct this slant and obtain an image as if the code image is captured squarely. As disclosed in JP 2005-26797 A, a method disclosed in “Calculation program for projective transformation with reliability estimation” (Shimizu, et al., Study Report of Information Processing Society of Japan 98-CVIM-111-5 (1998-05), pp. 33-40, May 27, 1998) may be used as a method of estimating parameters of the geometrical transformation. That is, a method for estimating parameters of the geometrical transformation from four reference points and four points obtained by geometrical transformation of the four reference points may be used. In this embodiment, because marker images are included outside the code image in the directions of the four vertices of the code image, it is possible to estimate the parameters of projective transformation (geometric transformation parameters) from the coordinates of these marker images in the captured image data.

The control section 22 executes a process for detecting and decoding the code image from the geometrically transformed image data. This process decodes a code from digital watermark data, and a widely known method can be employed.

Thus, according to this embodiment, a marker image is synthesized with a part of an original image outside a code image. The marker image includes a first region colored with a first color and a second region colored with a second color different from the first color. At least a part of the second region is in contact with the first region. Since the marker image includes the two color regions, a correction marker can be synthesized inside the original image in an easily detectable state, irrespective of colors of the original image. Therefore, an easily recognizable image is not arranged at the outer periphery of the original image, so that there is no impairment of the visual effect of the original image.

[Variations]

In the above-described embodiment, the regions where the marker image and the code image are synthesized are predetermined ones. Alternatively a region where the marker image will not be conspicuous may be searched for and the synthesizing locations of the code image and the marker image may be adjusted so that the marker image is arranged in this region. Examples of the regions where the marker image will not be conspicuous include a part of the original image where values of color components different from the color component in which the marker image is synthesized are not constant (for example, a part where the sum of the squares of differences between values of adjacent pixels is large). Specifically, in the example shown in FIG. 5, the “color component in which the marker image is synthesized” is blue component, and the “color components different from the color component in which the marker image is synthesized” are red and green components. The expression “values of color components different from the color component in which the marker image is synthesized are not constant” means values of R11 to R55 and G11 to G55 are not constant. In other words, since human's eyes recognize an object while seeing all R, G and B components, if R and G components vary busily, the marker formed of 0 and 255s of blue components is inconspicuous.

The colors of the marker image may be varied in correspondence with the content of the original image. For example, of the color components in the region in the original image where the marker image is to be synthesized, the color component with which the difference in values between before and after the marker image is synthesized is the smallest may be selected and set as the color of the marker image. For example, if the selected color component is the green component, the marker image is generated using the green component.

Also, the marker image does not have to be the shape of cross (plus sign) or a concentric rectangle shape like those discussed so far. For example, it may be the shape of concentric circles so long as at least a part of the second region is in contact with the first region or one of the first region and the second region is surrounded by the other.

What is claimed is:

1. An image processing apparatus comprising:
a first synthesizing section that synthesizes a code image with a part of an original image, the code image having a size smaller than that of the original image;
a second synthesizing section that synthesizes a marker image with another part of the original image outside the code image; and
an outputting section that outputs a synthesized image in which the original image, the code image and the marker image are synthesized, wherein:
the marker image includes a first region colored with a first color and a second region colored with a second color different from the first color,
at least a part of the second region is in contact with the first region, and
the marker image is used to correct slant of the code image when decoding the code image.

2. The image processing apparatus according to claim 1, wherein the first color and the second color are determined on a basis of a relation between the first and second colors and color components in a color space of read data of the synthesized image.

3. An image processing method comprising:
synthesizing a code image with a part of an original image, the code image having a size smaller than that of the original image;
synthesizing a marker image with another part of the original image outside the code image; and
outputting a synthesized image in which the original image, the code image and the marker image are synthesized, wherein:
the marker image includes a first region colored with a first color and a second region colored with a second color different from the first color,
at least a part of the second region is in contact with the first region, and
the marker image is used to correct slant of the code image when decoding the code image.

4. A medium on which a synthesized image is formed, wherein:
in the synthesized image, an original image, a code image and a marker image are synthesized,
the code image has a size smaller than that of the original image;
the marker image includes a first region colored with a first color and a second region colored with a second color different from the first color, and
at least a part of the second region is in contact with the first region, and
the marker image is synthesized with a part of the original image outside the code image.

5. A code reading apparatus comprising:
a generating section that captures the medium of claim 4 to generate image data;
an image processing section that detects the marker image from the generated image data and applies a predetermined image process to the generated image data on a basis of the code data; and
an outputting section that detects the code image from image data, which has been subject to the predetermined image process, encodes the detected code image and outputs a result of decoding.

6. A program stored in a recording medium, the program causing a computer to execute a process comprising:
synthesizing a code image with a part of an original image, the code image having a size smaller than that of the original image;
synthesizing a marker image with another part of the original image outside the code image; and
outputting a synthesized image in which the original image, the code image and the marker image are synthesized, wherein:
the marker image includes a first region colored with a first color and a second region colored with a second color different from the first color,
at least a part of the second region is in contact with the first region, and
the marker image is used to correct slant of the code image when decoding the code image.
